(19) United States
(12) Patent Application Publication
(10) Pub. No.: US 2026/0258229 A1
(43) Pub. Date: Sep. 3, 2026

(54) HIGH SOLIDS CONTENT CARBOXYMETHYLCELLULOSE SOLUTION

(71) Applicant: NOURYON CHEMICALS INTERNATIONAL B.V., Amsterdam (NL)

(72) Inventors: Anne Irmeli RUTANEN, Tikkakoski (FI); Kimmo Kalevi VESANEN, Jyväskylä (FI); Jaana Mirjami AHTIKARI, Laukaa (FI); Marko Juhani KANNIAINEN, Äänekoski (FI)

(73) Assignee: NOURYON CHEMICALS INTERNATIONAL B.V., Amsterdam (NL)

(21) Appl. No.: 18/878,376

(22) PCT Filed: Jun. 9, 2023
(86) PCT No.: PCT/EP2023/065502

§ 371 Date: Dec. 23, 2024

(30) Foreign Application Priority Data
Jun. 24, 2022 (EP) 22180926.2

(51) Int. Cl. C08L 1/28; C08J 3/05; C08K 11/00; D21H 19/34

(52) U.S. Cl. CPC C08L 1/286; C08J 3/05; C08K 11/00; D21H 19/34; C08J 2301/28; C08J 2401/28; C08L 2201/54; C08L 2205/025

(57) ABSTRACT

The present disclosure relates to a method for producing a carboxymethylcellulose (CMC) solution, the method comprising the following steps:
a) obtaining an aqueous solution comprising at least one low molecular weight CMC having a weight average molecular weight of less than 30 kDa; and
b) dissolving at least one high molecular weight CMC having a weight average molecular weight of at least 30 kDa into the solution of step a), wherein the at least one high molecular weight CMC is added as a solid to the solution of step a),
wherein the amount of low and high molecular weight CMC added in steps a) and b),
respectively, is such that the total amount of CMC in the solution is at least 18 wt. % relative to the total weight of the CMC solution.

### CROSS-REFERENCE TO RELATED APPLICATION

This application is a U.S. National-Stage entry under 35 U.S.C. § 371 based on International Application No. PCT/EP2023/065502, filed Jun. 9, 2023, which was published under PCT Article 21(2) and which claims priority to European Application No. EP 22180926.2, filed Jun. 24, 2022, which are all hereby incorporated in their entirety by reference.

### TECHNICAL FIELD

The present disclosure relates to a high solids content carboxymethylcellulose solution and preparation methods thereof.

### BACKGROUND

Cellulose ethers, such as carboxymethylcellulose (CMC), are typically delivered to end-users in powder form. However, in practice, the cellulose ether is normally required in the form of an aqueous solution, so the powder generally needs to be dissolved in water prior to use. The dissolution of the powder in water can be cost ineffective for the end-user. If the cellulose ether could be delivered in a pre-dissolved, high solids content form, then that would provide a cost competitive and more sustainable alternative for these end-users.

Due to its ability to impart rheological properties, improve water retention, improve the efficiency of optical brighteners, and provide strength, CMC is a popular additive in the paper and board industry, especially for coating, sizing, and base web manufacturing. In paper and board coating processes, CMC is added as a pre-dissolved solution (typically having 6 to 12 wt. % CMC) into the coating makedown composition, which usually includes inorganic pigments, organic binders, and additives such as dispersants, optical brighteners, crosslinkers, lubricants, and dyes. CMC also can be used as, or to make, a surface treatment, such as a barrier material. Barrier materials containing CMC can provide oil and grease resistance, oxygen resistance, or both. Common film coating technologies used to form barrier layers in the shape of a film include a size press, a metering size press, and various coating technologies. For each of these technologies, viscosity and/or solids content of the polymer solution that is used plays an important role. Not wishing to be bound by any theory, it is believed that uniform barrier layers result from a high enough coat weight, good film hold-out, or both. These properties may be more easily obtained by making a barrier material with CMC solutions of higher concentration. A higher concentration of CMC in solution is frequently achieved by degrading the CMC using various technologies. However, with these technologies the molecular weight of the CMC typically decreases so drastically that the resulting barrier layers do not have very good film hold-out and penetrate into a base web and thus do not provide required barrier properties.

The existing solutions of pre-dissolved CMCs having a low solids concentration generally will not enable formulation of a high solids content coating composition, and typically limit the amount of cellulose ether that can be used in the coating composition required for paper coating. Although dry addition of cellulose ethers to a high solids pigment slurry could resolve these issues, mills would need to have handling systems for powders, adequate manpower to add the powder by hand, or a mixing system capable of imparting sufficient shear to disperse the powder throughout the solution.

It is typically a challenge to get higher than 15 wt. % cellulose ether solution solids, particularly CMC solutions, without negatively impacting pumpability of the cellulose ether solution and maintaining performance. This is notably the case for high molecular weight cellulose ethers, as higher molecular weight cellulose ethers generally give rise to more viscous solutions. The low-shear viscosity limit for good pumpability with frequently used centrifugal pumps is considered to be about 5000 mPas (measured with Brookfield RV 100) at a typical process (pumping) temperature of about 25-60° C. This substantially reduces the upper concentration limit for high-Mw cellulose ether solutions, as higher concentrations of high-Mw cellulose ether solutions tend to have viscosities well in excess of these operating requirements.

As such, obtaining a high solids content cellulose ether solution containing increased quantities of high molecular weight cellulose ethers (for improved performance) whilst also maintaining low viscosity at low shear (for improved processability) is not a simple task.

Earlier solutions have been proposed to provide stable, concentrated, aqueous CMC suspensions. For example, U.S. Pat. No. 4,883,537 describes aqueous CMC solutions having decreased viscosity that include at least 33 weight percent potassium carbonate. However, the high concentration of potassium carbonate required can limit the usefulness of these solutions in applications and makes these compositions less attractive/desirable for high CMC solids content applications

WO 2009/061821 discloses methods of producing low-viscosity cellulose ether compositions using a combination of a very low molecular weight cellulose ether and a plasticizer.

WO 2013/057132 discloses methods of increasing the solids content of CMC in low-viscosity compositions. It was found that these methods made it possible to increase the solids content of CMC solutions to up to about 24 wt. % while maintaining solution pumpability. However, in practice those levels could only be reached with low molecular weight cellulose ethers, which provided limited performance as a coating thickener or as a barrier. Additionally, CMC solutions prepared according to the methods of WO 2013/057132 required the solution to have a pH of 7.5-11, which was found to reduce the shelf life of the CMC solution if the CMC solution contained impurities.

U.S. Pat. No. 5,080,717 discloses aqueous fluid suspensions of polysaccharide mixtures in paper coating compositions. These suspensions required stabilizing agents (e.g., xanthans).

Suspensions can be problematic due to their propensity for the suspended solid to settle (e.g., form aggregates, thus resulting in an inhomogeneous product wherein the suspended solid is unevenly distributed). This in turn can have a negative impact upon the application properties of said suspensions (e.g., uneven application of the actives), so the products of U.S. Pat. No. 5,080,717 still need to be dissolved before use. Solutions, on the other hand, do not suffer from this problem (i.e., the solute is evenly distributed within a homogeneous aqueous phase). Cellulose ether solutions are therefore much easier to handle and will generate more consistent results when used in the above-mentioned applications.

There remains a need for a method for preparing low viscosity carboxymethylcellulose solutions that have an increased amount of high molecular weight carboxymethylcellulose. If the CMC could be delivered in a ready-made solution with a high solids content, particularly with a high solids content of high molecular weight CMC, that would provide an improved product whilst also being a more cost effective and more sustainable alternative for end users. In addition, other objects, desirable features and characteristics will become apparent from the subsequent summary and detailed description, and the appended claims, taken in conjunction with the accompanying drawings and this background.

### BRIEF SUMMARY

This disclosure provides a method for producing a carboxymethylcellulose (CMC) solution, the method comprising the following steps:
a) obtaining an aqueous solution comprising at least one low molecular weight CMC having a weight average molecular weight of less than 30 kDa; and
b) dissolving at least one high molecular weight CMC having a weight average molecular weight of at least 30 kDa into the solution of step a), wherein the at least one high molecular weight CMC is added as a solid to the solution of step a),
wherein the amount of low and high molecular weight CMC added in steps a) and b), respectively, is such that the total amount of CMC in the final solution is at least 18 wt. % relative to the total weight of the CMC solution.

This disclosure also provides a carboxymethylcellulose (CMC) solution comprising:
a) water;
b) at least one low molecular weight CMC having a weight average molecular weight of less than 30 kDa; and
c) at least one high molecular weight CMC having a weight average molecular weight of at least 30 kDa,
wherein the total amount of CMC in the solution is at least 18 wt. % relative to the total weight of the CMC solution, and wherein the CMC solution has a viscosity 5000 mPas or less as determined using Brookfield RV, 100 rpm, 40° C., spindle 6.

### DETAILED DESCRIPTION

The following detailed description is merely exemplary in nature and is not intended to limit the present disclosure or the application and uses of the present disclosure. Furthermore, there is no intention to be bound by any theory presented in the preceding background of the present disclosure or the following detailed description. It is to be appreciated that all numerical values as provided herein, save for the actual examples, are approximate values with endpoints or particular values intended to be read as “about” or “approximately” the value as recited.

The present inventors have developed a simple, yet highly effective method for preparing carboxymethylcellulose (CMC) solutions that satisfy this need. Accordingly, in a first aspect, the present disclosure relates to a method for producing a high solids, low viscosity CMC solution, the method comprising the following steps:
a. obtaining an aqueous solution comprising at least one low molecular weight CMC having a weight average molecular weight of less than 30 kDa; and
b. dissolving at least one high molecular weight CMC having a weight average molecular weight of at least 30 kDa into the solution of step a), wherein the at least one high molecular weight CMC is added as a solid (preferably as a powder) to the solution of step a),
wherein the amount of low and high molecular weight CMC added in steps a) and b),
respectively, is such that the total amount of CMC in the solution is at least 18 wt. %, preferably at least 20 wt. %, preferably at least 25 wt. %, preferably at least 28 wt. %, and most preferably at least 30 wt. % (in each case, wt. % being relative to the total weight of the CMC solution). In a further optional step, the CMC content (wt. %) in the final solution may be adjusted to a desired value by adding water to the CMC solution.

A surprising finding was that the total amount of the high molecular weight CMC in the solution could be substantially increased without requiring the use of stabilizing agents and whilst unexpectedly maintaining a low viscosity solution (<5000 mPas) by adding the high molecular weight CMC as a solid, preferably as a powder, to the aqueous solution of the low molecular weight CMC of step a). This new way of combining the two different CMCs results in higher total solids contents of the CMC whilst also providing a much-improved rheological profile for such high solids content CMC solutions vis-à-vis CMC solutions produced via conventional methods.

The high molecular weight CMC in solid form, preferably in powder form, may contain substantial amounts of residual moisture when in the solid form (e.g., water of hydration or the like). It is preferred if the solid (preferably powder form) high molecular weight CMC has a total water content of less than 60 wt. %, preferably less than 50 wt. %, and more preferably less than 40 wt. % (relative to the total weight of the solid high molecular weight CMC).

The solid (preferably in powder form) high molecular weight CMC used in the above method is preferably substantially dry (i.e., subjected to a drying step prior to its use in step b)). As used herein, a “substantially dry” solid (preferably in powder form) high molecular weight CMC has a total water content of 15 wt. % or less, preferably 10 wt. % or less (in each case, wt. % being relative to the total weight of the substantially dry solid—preferably in powder form—high molecular weight CMC).

The weight average molecular weight of the at least one low molecular weight CMC is preferably less than 20 kDa, more preferably less than 15 kDa.

The weight average molecular weight of the at least one high molecular weight CMC may be at least 40 kDa, and may be at least 50 kDa, at least 75 kDa, or at least 100 kDa.

“Weight average molecular weight” as used herein was determined using a Malvern Omnisec Gel Permeation Chromatography system with multidetector module and Viscotek ALS6000Mx2 (13 μm, 300*8.0 mm) columns. The column temperature was at 35° C. The eluent used was 0.1 M aqueous sodium nitrate with 10% (V/V) methanol with flow rate 0.8 ml/min. The single sample injection volume was 100 ul and sample concentration 1 mg/ml. The molar mass was determined as average of three (3) injections each from a separate sample vial. The determinations were calibrated with pullulan standard (Mw 113 kDa, PDI 1.13, Polymer Standards Service). The data was processed with Omnisec 5-software.

For the avoidance of doubt, the total amount of CMC in the CMC solution is the weight percentage of CMC in the solution (i.e., wt. % of CMC relative to the total weight of the CMC solution). The total amount of CMC in a CMC solution can be easily determined and easily controlled by persons skilled in the art using routine skills.

Preferably, the amount of low and high molecular weight CMC added in steps a) and b), respectively, is such that total amount of CMC in the CMC solution is at least 20 wt. %, preferably at least 25 wt. %, preferably at least 28 wt. %, and most preferably at least 30 wt. %, such as from about 30-40 wt % (in each case, wt. % being relative to the total weight of the CMC solution). In a preferred embodiment, the amount of low and high molecular weight CMC added in steps a) and b), respectively, is such that the total amount of CMC in the CMC solution is from about 18 to 50 wt. %, preferably from about 20 to 50 wt. %, more preferably from about 20 to 40 wt. %, and more preferably from about 30 to 40 wt. % (each being relative to the total weight of the CMC solution).

Preferably, the amount of low and high molecular weight CMC added in steps a) and b), respectively, is such that the total amount of the low molecular weight CMC in the final solution is at least about 15 wt. %, preferably at least about 18 wt. %, more preferably at least about 20 wt. %, and the total amount of high molecular weight CMC in the final solution is at least 5 wt. %, more preferably at least about 8 wt. %, more preferably at least about 10 wt. %, more preferably at least about 15 wt. % (each being relative to the total weight of the CMC solution).

Preferably, the weight ratio of the low molecular weight CMC to the high molecular weight CMC in the CMC solution (low Mw:high Mw) is from about 3:7 to 9:1, preferably about 1:2 to 5:1, more preferably about 1:2 to 4:1, and most preferably about 1:1 to 4:1.

In a preferred embodiment, the total amount of CMC in the CMC solution is from 20 to 50 wt. %, the amount of the low molecular weight CMC is from about 15 to 45 wt. %, and the amount of the high molecular weight CMC is from about 5 to 35 wt. % (in each case, wt. % being relative to the total weight of the CMC solution). In another preferred embodiment, the total amount of CMC in the CMC solution is from 20 to 40 wt. %, the amount of the low molecular weight CMC is from about 15 to 35 wt. %, and the amount of the high molecular weight CMC is from about 5 to 25 wt. % (in each case, wt. % being relative to the total weight of the CMC

### Solution

Preferably, the weight average molecular weight of the low molecular weight CMC is less than 20 kDa and the weight average molecular weight of the high molecular weight CMC is greater than 30 kDa. Preferably, the weight average molecular weight of the low molecular weight CMC is less than 15 kDa and the weight average molecular weight of the high molecular weight CMC is greater than 30 kDa.

Preferably, the weight average molecular weight of the low molecular weight CMC is less than 30 kDa and the weight average molecular weight of the high molecular weight CMC is greater than 50 kDa. Preferably, the weight average molecular weight of the low molecular weight CMC is less than 30 kDa and the weight average molecular weight of the high molecular weight CMC is greater than 75 kDa. Preferably, the weight average molecular weight of the low molecular weight CMC is less than 30 kDa and the weight average molecular weight of the high molecular weight CMC is greater than 100 kDa.

Preferably, the weight average molecular weight of the low molecular weight CMC is less than 20 kDa and the weight average molecular weight of the high molecular weight CMC is greater than 50 kDa. Preferably, the weight average molecular weight of the low molecular weight CMC is less than 20 kDa and the weight average molecular weight of the high molecular weight CMC is greater than 75 kDa. Preferably, the weight average molecular weight of the low molecular weight CMC is less than 20 kDa and the weight average molecular weight of the high molecular weight CMC is greater than 100 kDa.

Preferably, the weight average molecular weight of the low molecular weight CMC is less than 15 kDa and the weight average molecular weight of the high molecular weight CMC is greater than 50 kDa. Preferably, the weight average molecular weight of the low molecular weight CMC is less than 15 kDa and the weight average molecular weight of the high molecular weight CMC is greater than 75 kDa. Preferably, the weight average molecular weight of the low molecular weight CMC is less than 15 kDa and the weight average molecular weight of the high molecular weight CMC is greater than 100 kDa.

CMCs having molecular weights in accordance with the above preferred embodiments are well known in the art. Many suitable CMCs are commercially available. Any suitable method for obtaining such CMCs may be used in conjunction with the above-described method for producing a high solids content CMC solution.

The degree of substitution of the CMCs can also affect the solubility of the solid high Mw CMC in the low Mw CMC solution. In that respect, the high-Mw CMCs preferably have a degree of anionic substitution (“DS_{A}”) in the range of from about 0.4 to about 1.5. The solubility of the high Mw CMC in the low Mw CMC is optimal if the high Mw CMC has a DS_{A} within this range. The term “degree of anionic substitution” or “DS_{A}” means the average number of substituted ring sites of the beta-anhydroglucose rings of the cellulose derivative, wherein the substituent is anionic (in this instance a carboxymethyl group). Since there are three hydroxyl groups on each anhydroglucose ring of the cellulose that are available for substitution, the maximum value of DS_{A} is 3.0.

It is also preferred if the low Mw CMC also has a degree of anionic substitution (“DS_{A}”) in the range of from about 0.4 to about 1.5.

Accordingly, in a preferred embodiment, the low molecular weight CMC has a weight average molecular weight of less than 30 kDa, preferably less than 20 kDa, more preferably less than 15 kDa, and the high molecular weight CMC has a DS_{A} of about 0.4 to about 1.5 and a weight average molecular weight of at least 30 kDa, more preferably 50 kDa, more preferably at least 75 kDa, more preferably at least 100 kDa.

In a more preferred embodiment, the low molecular weight CMC has a DS_{A} of about 0.4 to about 1.5 and a weight average molecular weight of less than 30 kDa, preferably less than 20 kDa, more preferably less than 15 kDa, and the high molecular weight CMC has a DS_{A} of about 0.4 to about 1.5 and a weight average molecular weight of at least 30 kDa, more preferably 50 kDa, more preferably at least 75 kDa, more preferably at least 100 kDa.

Thus, in a preferred embodiment, the method for producing a high solids, low viscosity CMC solution, comprises the following steps:
a. obtaining an aqueous solution comprising at least one low molecular weight carboxymethylcellulose (CMC) having a weight average molecular weight of less than 30 kDa; and
b. dissolving at least one high molecular weight CMC having a weight average molecular weight of at least 30 kDa into the solution of step a), wherein the at least one high molecular weight CMC is added as a (preferably substantially dry) solid (preferably in powder form) to the solution of step a),
wherein the amount of low and high molecular weight CMC added in steps a) and b) is such that the total amount of CMC in the solution is from about 20 to 50 wt. %, and the amount of low and high molecular weight CMC added in steps a) and b), respectively, is such that the amount of the low molecular weight CMC in the final solution is at least 15 wt. % and the amount of high molecular weight CMC in the final solution is at least 5 wt. % (in each case, wt. % being relative to the total weight of the CMC solution).

In a further preferred embodiment, the method for producing a high solids, low viscosity CMC solution, comprises the following steps:
a. obtaining an aqueous solution comprising at least one low molecular weight carboxymethylcellulose (CMC) having a weight average molecular weight of less than 30 kDa; and
b. dissolving at least one high molecular weight CMC having a weight average molecular weight of at least 30 kDa into the solution of step a), wherein the at least one substantially dry high molecular weight CMC is added as a (preferably substantially dry) solid (preferably in powder form) to the solution of step a),
wherein the amount of low and high molecular weight CMC added in steps a) and b) is such that the total amount of CMC in the solution is from about 20 to 50 wt. %, and the amount of low and high molecular weight CMC added in steps a) and b), respectively, is such that the amount of the low molecular weight CMC in the final solution is at least 15 wt. % and the amount of high molecular weight CMC in the final solution is at least 5 wt. % (in each case, wt. % being relative to the total weight of the CMC solution), and wherein the weight ratio of the low molecular weight CMC to the high molecular weight CMC in the final solution is from about 3:7 to 9:1, preferably about 1:2 to 5:1, more preferably about 1:2 to 4:1, and most preferably about 1:1 to 4:1.

In a further preferred embodiment, the method for producing a high solids, low viscosity CMC solution, comprises the following steps:
a. obtaining an aqueous solution comprising at least one low molecular weight carboxymethylcellulose (CMC) having a weight average molecular weight of less than 30 kDa and a DS_{A} of about 0.4 to about 1.5; and
b. dissolving at least one high molecular weight CMC having a weight average molecular weight of at least 30 kDa and a DS_{A} of about 0.4 to about 1.5 into the solution of step a), wherein the at least one high molecular weight CMC is added as a (preferably substantially dry) solid (preferably in powder form) to the solution of step a),
wherein the amount of low and high molecular weight CMC added in steps a) and b) is such that the total amount of CMC in the solution is from about 20 to 50 wt. %, and the amount of low and high molecular weight CMC added in steps a) and b), respectively, is such that the amount of the low molecular weight CMC in the final solution is at least 15 wt. % and the amount of high molecular weight CMC in the final solution is at least 5 wt. % (in each case, wt. % being relative to the total weight of the CMC solution), and wherein the weight ratio of the low molecular weight CMC to the high molecular weight CMC in the final solution is from about 3:7 to 9:1, preferably about 1:2 to 5:1, more preferably about 1:2 to 4:1, and most preferably about 1:1 to 4:1.

Preferably, the at least one high molecular weight CMC is added as a (preferably substantially dry) solid (preferably in powder form) to the solution of step a) at a temperature of from about 20° C. to 70° C., preferably from about 25° C. to 65° C., preferably from about 25° C. to 60° C. (i.e., the solution of step a) is preferably adjusted to a temperature of about 20° C. to 70° C., preferably about 25-65° C., preferably about 25-60° C., before addition of the high molecular weight CMC). As such, in a further preferred embodiment, the method for producing a high solids, low viscosity CMC solution, comprises the following steps:
a. obtaining an aqueous solution comprising at least one low molecular weight CMC having a weight average molecular weight of less than 30 kDa;
b. adjusting the temperature of the solution of step a) to about 20° C. to about 70° C., and
c. dissolving at least one high molecular weight CMC having a weight average molecular weight of at least 30 kDa into the solution of step b), wherein the at least one high molecular weight CMC is added as a (preferably substantially dry) solid (preferably in powder form) to the solution of step b),
wherein the amount of low and high molecular weight CMC added in steps a) and c) is such that the total amount of CMC in the solution is at least 18 wt. % (relative to the total weight of the CMC solution).

In a further preferred embodiment, the method for producing a high solids, low viscosity CMC solution, comprises the following steps:
a. obtaining an aqueous solution comprising at least one low molecular weight carboxymethylcellulose (CMC) having a weight average molecular weight of less than 30 kDa and optionally a DS_{A} of about 0.4 to about 1.5;
b. adjusting the temperature of the solution of step a) to about 25° C. to 65° C., and
c. dissolving at least one high molecular weight CMC having a weight average molecular weight of at least 30 kDa, and optionally a DS_{A} of about 0.4 to about 1.5, into the solution of step b), wherein the at least one high molecular weight CMC is added as a (preferably substantially dry) solid (preferably in powder form) to the solution of step b),
wherein the amount of low and high molecular weight CMC added in steps a) and c) is such that the total amount of CMC in the solution is from about 20 to 50 wt. %, and the amount of low and high molecular weight CMC added in steps a) and b), respectively, is such that the amount of the low molecular weight CMC in the final solution is at least 15 wt. % and the amount of high molecular weight CMC in the final solution is at least 5 wt. % (in each case, wt. % being relative to the total weight of the CMC solution), and wherein the weight ratio of the low molecular weight CMC to the high molecular weight CMC in the final solution is optionally from about 3:7 to 9:1, preferably about 1:2 to 5:1, more preferably about 1:2 to 4:1, and most preferably about 1:1 to 4:1.

The present disclosure, of course, also relates to the CMC solutions produced by the above-described method and preferred embodiments thereof. As explained above, these CMC solutions are exemplified in that they contain large amounts (wt. %) of CMC whilst having unexpectedly beneficial rheological properties for such solutions (notably a surprisingly low viscosity). In that respect, in a second aspect the present disclosure relates to a high solids, low viscosity CMC solution comprising:
a. water;
b. at least one low molecular weight CMC having a weight average molecular weight of less than 30 kDa; and
c. at least one high molecular weight CMC having a weight average molecular weight of at least 30 kDa,
wherein the total amount of CMC in the solution is at least 18 wt. % (relative to the total weight of the CMC solution), and wherein the CMC solution has a viscosity of 5000 mPas or less (Brookfield RV, 100 rpm, 40° C., spindle 6).

In a preferred embodiment, the CMC solution comprises:
a. water;
b. at least one low molecular weight CMC having a weight average molecular weight of less than 30 kDa; and
c. at least one high molecular weight CMC having a weight average molecular weight of at least 30 kDa,
wherein the total amount of CMC in the solution is at least 20 wt. %, wherein the amount of the low molecular weight CMC in the final solution is at least 15 wt. % and the amount of high molecular weight CMC in the final solution is at least 5 wt. % (in each case, wt. % being relative to the total weight of the CMC solution), and wherein the CMC solution has a viscosity of 5000 mPas or less (Brookfield RV, 100 rpm, 40° C., spindle 6).

In another preferred embodiment, the CMC solution comprises:
a. water;
b. at least one low molecular weight CMC having a weight average molecular weight of less than 30 kDa; and
c. at least one high molecular weight CMC having a weight average molecular weight of at least 30 kDa,
wherein the total amount of CMC in the solution is from about 20 to 40 wt. %, wherein the amount of the low molecular weight CMC in the final solution is at least 15 wt. % and the amount of high molecular weight CMC in the final solution is at least 5 wt. % (in each case, wt. % being relative to the total weight of the CMC solution), wherein the weight ratio of the low molecular weight CMC to the high molecular weight CMC in the final solution is from about 3:7 to 9:1, preferably about 1:2 to 5:1, more preferably about 1:2 to 4:1, and most preferably about 1:1 to 4:1, and wherein the CMC solution has a viscosity of 5000 mPas or less (Brookfield RV, 100 rpm, 40° C., spindle 6).

In another preferred embodiment, the CMC solution comprises:
a. water;
b. at least one low molecular weight CMC having a weight average molecular weight of less than 30 kDa and a DS_{A} of 0.4 to about 1.5, and
c. at least one high molecular weight CMC having a weight average molecular weight of at least 30 kDa and a DS_{A} of 0.4 to about 1.5.
wherein the total amount of CMC in the solution is from about 20 to 50 wt. %, wherein the amount of the low molecular weight CMC in the final solution is at least 15 wt. % and the amount of high molecular weight CMC in the final solution is at least 5 wt. % (in each case, wt. % being relative to the total weight of the CMC solution), wherein the weight ratio of the low molecular weight CMC to the high molecular weight CMC in the final solution is from about 3:7 to 9:1, preferably about 1:2 to 5:1, more preferably about 1:2 to 4:1, and most preferably about 1:1 to 4:1, and wherein the CMC solution has a viscosity of 5000 mPas or less (Brookfield RV, 100 rpm, 40° C., spindle 6).

Preferably, the CMC solution contains at least 40 wt. % water. In that respect, the CMC solution may contain water in an amount of from about 40 wt. % to 82 wt. %, preferably from about 50 wt. % to 80 wt. %, more preferably from about 60 wt. % to about 70 wt. % (in each case, wt. % being relative to the total weight of the CMC solution).

The CMC solutions produced by the above-described method may also comprise a plasticizer, such as, but not limited to, sorbitol, glycerol, mannitol, and/or xylitol. The plasticizer may be present in any suitable amount, such as from 1-50 wt. % (relative to the total weight of the CMC solution). The high solids content CMC solution may also comprise further additives conventionally used in barrier coating applications, such as crosslinkers, pigments, etc.

The high solids content CMC solution preferably has a pH of about 4.5 to about 7.5. An unexpected finding was that the CMC solution could be produced by the methods described with a pH in this range, which generally improved the shelf-life of the solution, irrespective of whether impurities were present in the solution.

In a third aspect, the present disclosure relates to the use of a high solids content CMC solution as described above as a surface treatment agent, e.g., barrier coating, for paper and board substrates.

In a fourth aspect, the present disclosure relates to a method for treating a surface of a paper or board substrate comprising applying a high solids content CMC solution as described above to the surface of the paper or board substrate.

In a fifth aspect, the present disclosure relates to a surface treated paper or board substrate obtainable by the method of the fourth aspect of the present disclosure.

In a sixth aspect, the present disclosure relates to the use of a high solids content CMC solution as described above as a co-binder and/or thickener.

### EXAMPLES

The following examples provide a detailed method for working the present disclosure. These worked examples are exemplary in nature and not intended to be limitative.

### Example 1

As noted above, the conventional method for preparing mixtures of two different cellulose ethers is to prepare a solution of each cellulose ether and then mix the two in the required amounts to obtain the required ratio of cellulose ethers. As noted above, however, there is a limit on how much high-Mw cellulose ether can be dissolved before the resulting solution can no longer be suitably processed (i.e., is not pumpable). This limits the total maximum solids content that can be achieved for solutions containing high-Mw cellulose ethers, which in turn hinders the ability to achieve the desired barrier properties of the coating.

To exemplify this problem, two CMCs were selected:

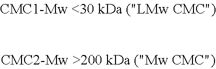

For a solution of CMC1 only, it was found that the maximum total solids that could be achieved was about 35 wt. %.

For a solution of CMC2 only, however, it was found that the maximum total solids that could be achieved was about 5 wt. % (limited by the high Mw, >200 kDa; the 5 wt. % solution had a viscosity of >20000 mPas at 25° C.).

To increase the total solids content of a solution comprising CMC2, the inventors aimed to produce a solution wherein the solids content ratio of CMC1 to CMC2 was 80:20. This was achieved by mixing 229 grams of the solution of CMC1 and 400 grams of the solution of CMC2 to arrive at the desired solids content ratio. It was found that the total CMC content that could be achieved for an 80:20 weight ratio (CMC1:CMC2) by the conventional method (mixing solutions) was about 16 wt. %.

However, by first preparing a ~25.5% solution of the low-Mw CMC (i.e., no need for maximum solids) and then mixing (at 600 rpm and at 60° C.) the required amount (22 grams) of high-Mw CMC in a substantially dry powder form (8 wt. % moisture content) into the low-Mw CMC solution to produce the desired 80:20 ratio, it was possible to produce a CMC solution with about double the total CMC content (30 wt. %):

TABLE 1

| | Conventional | Inventive |
|---|---|---|
| CMC1 Solution, (CMC1 wt. %) | 35 (max) | 25.5 |
| CMC2 Solution, (CMC2 wt. %) | 5 (max) | — |
| CMC2 dry material, moisture 8%, | — | 92 |
| (CMC2 wt. %) | | |
| Weight Ratio CMC1:CMC2 | 80:20 | 80:20 |
| Final Solution Content of CMC (wt. %) | 16 (max) | 30 |
| Final Solution Content of HMw CMC | 3.2 (max) | 6.0 |
| (wt. %) | | |

This demonstrates the substantial improvement provided by the present method in terms of substantially increasing not only the total quantity of CMC, but substantially increasing the total quantity of the high molecular weight CMC in the CMC solution.

The inventive CMC solution would be particularly suitable as a thickener in paper and board coatings.

### Example 2

A further study was performed to determine whether the relative concentration of the high-Mw CMC could be further increased whilst maintaining the excellent rheological properties of the solution.

In that respect, a second set of CMCs were tested:

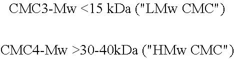

For these CMCs, it was found that it was again possible to produce a CMC solution with a high total solids content when following the method disclosed herein. Of note is that it was possible to increase the low to high Mw CMC weight ratio to 1:1 whilst maintaining the high total amount of CMC and excellent rheological profile. To achieve this, a 25.5% solution of the low-Mw CMC (196 grams; 49.98 g dry low-Mw CMC) was mixed (60° C., 600 rpm) with the required amount of high-Mw CMC (~54 grams; 49.68 g dry high Mw-CMC) in a substantially dry form (8% moisture content) to produce the desired 1:1 ratio. The resulting CMC solution was adjusted to a final CMC content of 25 wt. % by diluting with water:

TABLE 2

| | Inventive |
|---|---|
| Weight Ratio CMC3:CMC4 | 1:1 |
| Final Solution Content of CMC (wt. %) | 25 |
| Final Solution Content of HMw CMC (wt. %) | 12.5 |
| Viscosity (mPas; Brookfield RV, spindle 6, | 3400 |
| 100 rpm, 40° C.) | |

The inventors were unable to produce an equivalent solution with such a high concentration of the high Mw CMC and low viscosity when using other known processes (including the solution mixing process set out in Example 1); the conventional method (cf. Example 1) reached a maximum total CMC content of 17.8 wt. % (1:1 ratio, low Mw:high Mw).

As such, the inventors have now developed a method for producing CMC solutions containing, to the best of the inventors' knowledge, previously unattainable levels of HMw CMC whilst having rheological properties that make them suitable for use in paper/board coating and barrier applications.

To summarise, the inventors have developed an improved method for preparing solutions of CMCs with a substantially increased total amount of CMC, particularly with respect to the high Mw CMC, whilst maintaining excellent rheological properties.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment as contemplated herein. It should be understood that various changes may be made in the function and arrangement of elements described in an exemplary embodiment without departing from the scope of the present disclosure as set forth in the appended claims.

The present disclosure may be further described by the following Aspects.

Aspect 1. A method for producing a high solids, low viscosity carboxymethylcellulose (CMC) solution, the method comprising the following steps:
a. obtaining an aqueous solution comprising at least one low molecular weight CMC having a weight average molecular weight of less than 30 kDa; and
b. dissolving at least one high molecular weight CMC having a weight average molecular weight of at least 30 kDa into the solution of step a), wherein the at least one high molecular weight CMC is added as a solid (preferably as a powder) to the solution of step a), wherein the amount of low and high molecular weight CMC added in steps a) and b), respectively, is such that the total amount of CMC in the solution is at least 18 wt. % (relative to the total weight of the CMC solution).

Aspect 2. The method of Aspect 1, wherein the amount of low and high molecular weight CMC added in steps a) and b), respectively, is such that the total amount of CMC in the solution is at least 20 wt. %, preferably at least 25 wt. %, preferably at least 28 wt. %, and most preferably at least 30 wt. % (in each case, wt. % being relative to the total weight of the CMC solution).

Aspect 3. The method of Aspects 1 or 2, wherein the amount of low and high molecular weight CMC added in steps a) and b), respectively, is such that the total amount of CMC in the CMC solution is from about 18 to 50 wt. %.

Aspect 4. The method of any one of Aspects 1-3, wherein the amount of low and high molecular weight CMC added in steps a) and b), respectively, is such that the total amount of CMC in the CMC solution is from about 20 to 40 wt. %.

Aspect 5. The method of any one of Aspects 1-4, wherein the amount of low and high molecular weight CMC added in steps a) and b), respectively, is such that the total amount of the low molecular weight CMC in the final solution is at least about 15 wt. % and the total amount of high molecular weight CMC in the final solution is at least 5 wt. % (in each case, wt. % being relative to the total weight of the CMC solution).

Aspect 6. The method of any one of Aspects 1-5, wherein the total amount of CMC in the CMC solution is from 20 to 50 wt. %, the amount of the low molecular weight CMC is from about 15 to 45 wt. %, and the amount of the high molecular weight CMC is from about 5 to 35 wt. % (in each case, wt. % being relative to the total weight of the CMC solution).

Aspect 7. The method of any one of Aspects 1-6, wherein the weight ratio of the low molecular weight CMC to the high molecular weight CMC in the CMC solution (low Mw:high Mw) is from about 3:7 to 9:1.

Aspect 8. The method of any one of Aspects 1-7, wherein the total amount of CMC in the CMC solution is from 20 to 40 wt. %, the amount of the low molecular weight CMC is from about 15 to 35 wt. %, and the amount of the high molecular weight CMC is from about 5 to 25 wt. % (in each case, wt. % being relative to the total weight of the CMC solution).

Aspect 9. The method of any one of Aspects 1-8, wherein the weight ratio of the low molecular weight CMC to the high molecular weight CMC in the CMC solution (low Mw:high Mw) is from about 1:2 to 5:1.

Aspect 10. The method of any one of Aspects 1-9, wherein the weight ratio of the low molecular weight CMC to the high molecular weight CMC in the CMC solution (low Mw:high Mw) is from about 1:1 to 4:1.

Aspect 11. The method of any one of Aspects 1-10, wherein the solid high molecular weight CMC is in a powder form.

Aspect 12. The method of any one of Aspects 1-11, wherein the solid high molecular weight CMC is a substantially dry solid having a total water content of 15 wt. % or less (relative to the total weight of the substantially dry solid high molecular weight CMC).

Aspect 13. The method of any one of Aspects 1-12, wherein the weight average molecular weight of the low molecular weight CMC is less than 20 kDa and the weight average molecular weight of the high molecular weight CMC is greater than 30 kDa.

Aspect 14. The method of any one of Aspects 1-12, wherein the weight average molecular weight of the low molecular weight CMC is less than 15 kDa and the weight average molecular weight of the high molecular weight CMC is greater than 30 kDa.

Aspect 15. The method of any one of Aspects 1-12 wherein the weight average molecular weight of the low molecular weight CMC is less than 30 kDa and the weight average molecular weight of the high molecular weight CMC is greater than 50 kDa.

Aspect 16. The method of any one of Aspects 1-12, wherein the weight average molecular weight of the low molecular weight CMC is less than 30 kDa and the weight average molecular weight of the high molecular weight CMC is greater than 75 kDa.

Aspect 17. The method of any one of Aspects 1-12, wherein the weight average molecular weight of the low molecular weight CMC is less than 30 kDa and the weight average molecular weight of the high molecular weight CMC is greater than 100 kDa.

Aspect 18. The method of any one of Aspects 1-12, wherein the weight average molecular weight of the low molecular weight CMC is less than 20 kDa and the weight average molecular weight of the high molecular weight CMC is greater than 50 kDa.

Aspect 19. The method of any one of Aspects 1-12, wherein the weight average molecular weight of the low molecular weight CMC is less than 20 kDa and the weight average molecular weight of the high molecular weight CMC is greater than 75 kDa.

Aspect 20. The method of any one of Aspects 1-12, wherein the weight average molecular weight of the low molecular weight CMC is less than 20 kDa and the weight average molecular weight of the high molecular weight CMC is greater than 100 kDa.

Aspect 21. The method of any one of Aspects 1-12, wherein the weight average molecular weight of the low molecular weight CMC is less than 15 kDa and the weight average molecular weight of the high molecular weight CMC is greater than 50 kDa.

Aspect 22. The method of any one of Aspects 1-12, wherein the weight average molecular weight of the low molecular weight CMC is less than 15 kDa and the weight average molecular weight of the high molecular weight CMC is greater than 75 kDa.

Aspect 23. The method of any one of Aspects 1-12, wherein the weight average molecular weight of the low molecular weight CMC is less than 15 kDa and the weight average molecular weight of the high molecular weight CMC is greater than 100 kDa.

Aspect 24. The method of any one of Aspects 1-12, wherein the weight average molecular weight of the low molecular weight CMC is less than 15 kDa and the weight average molecular weight of the high molecular weight CMC is from >30 up to about 50 kDa.

Aspect 25. The method of any one of Aspects 1-24, wherein the high molecular weight CMC has a degree of anionic substitution (DSA) of about 0.4 to about 1.5.

Aspect 26. The method of any one of Aspects 1-25, wherein the low molecular weight CMC has a degree of anionic substitution (DSA) of about 0.4 to about 1.5.

Aspect 27. The method of any one of Aspects 1-26, wherein the low molecular weight CMC has a degree of anionic substitution (DSA) of about 0.4 to about 1.5 and wherein the high molecular weight CMC has a degree of anionic substitution (DSA) of about 0.4 to about 1.5.

Aspect 28. The method of any one of Aspects 24-27, wherein the high molecular weight CMC has a weight average molecular weight of greater than 30 kDa and wherein the low molecular weight CMC has a weight average molecular weight of less than 20 kDa.

Aspect 29. The method of any one of Aspects 1-28, wherein aqueous the solution of step a) is adjusted to a temperature of about 25-60° C. before step b).

Aspect 30. The method of any one of Aspects 1-29, wherein the CMC solution further comprises a plasticizer.

Aspect 31. The method of any one of Aspects 1-30, wherein the pH of the CMC solution is from about 4.5 to about 7.5

Aspect 32. A CMC solution obtainable by the method of any one of Aspects 1-31.

Aspect 33. A CMC solution comprising:
water;
at least one low molecular weight CMC having a weight average molecular weight of less than 30 kDa; and
at least one high molecular weight CMC having a weight average molecular weight of at least 30 kDa,
wherein the total amount of CMC in the solution is at least 18 wt. % (relative to the total weight of the CMC solution), and wherein the CMC solution has a viscosity of 5000 mPas or less (Brookfield RV, 100 rpm, 40° C., spindle 6).

Aspect 34. The CMC solution of Aspect 33, wherein the CMC solution comprises:
water;
at least one low molecular weight CMC having a weight average molecular weight of less than 30 kDa; and
at least one high molecular weight CMC having a weight average molecular weight of at least 30 kDa, wherein the total amount of CMC in the solution is at least 20 wt. %, wherein the amount of the low molecular weight CMC in the solution is at least 15 wt. % and the amount of high molecular weight CMC in the solution is at least 5 wt. % (in each case, wt. % being relative to the total weight of the CMC solution), and wherein the CMC solution has a viscosity of 5000 mPas or less (Brookfield RV, 100 rpm, 40° C., spindle 6).

Aspect 35. The CMC solution of Aspects 33 or 34, wherein the total amount of CMC in the solution is from about 20 to 40 wt. %, wherein the amount of the low molecular weight CMC in the final solution is at least 15 wt. % and the amount of high molecular weight CMC in the final solution is at least 5 wt. % (in each case, wt. % being relative to the total weight of the CMC solution).

Aspect 36. The CMC solution of any one of Aspects 33-35, wherein the weight ratio of the low molecular weight CMC to the high molecular weight CMC in the final solution is from about 3:7 to 9:1.

Aspect 37. The CMC solution of any one of Aspects 33-36, wherein the weight ratio of the low molecular weight CMC to the high molecular weight CMC in the final solution is from about 1:2 to 5:1.

Aspect 38. The CMC solution of any one of Aspects 33-37, wherein the weight ratio of the low molecular weight CMC to the high molecular weight CMC in the final solution is from about 1:2 to 4:1.

Aspect 39. The CMC solution of any one of Aspects 33-38, wherein the weight ratio of the low molecular weight CMC to the high molecular weight CMC in the final solution is from about 1:1 to 4:1.

Aspect 40. The CMC solution of any one of Aspects 33-39, wherein the at least one low molecular weight CMC has a weight average molecular weight of less than 30 kDa and a DSA of 0.4 to about 1.5.

Aspect 41. The CMC solution of any one of Aspects 33-39, wherein the at least one low molecular weight CMC has a weight average molecular weight of less than 15 kDa and a DSA of 0.4 to about 1.5.

Aspect 42. The CMC solution of any one of Aspects 33-41, wherein the at least one high molecular weight cellulose CMC has a weight average molecular weight of more than 30 kDa and a DSA of 0.4 to about 1.5.

Aspect 43. The CMC solution of any one of Aspects 33-42, wherein the at least one high molecular weight cellulose CMC has a weight average molecular weight of more than 30 kDa up to about 50 kDa and a DSA of 0.4 to about 1.5.

Aspect 44. The CMC solution of any one of Aspects 33-43, wherein the CMC solution contains at least 40 wt. % water.

Aspect 45. The CMC solution of any one of Aspects 33-44, wherein the CMC solution further comprises at least one plasticizer.

Aspect 46. The CMC solution of Aspect 45, wherein the plasticizer is selected from sorbitol, glycerol, mannitol, and/or xylitol.

Aspect 47. The CMC solution of any one of Aspects 44-46, wherein the CMC solution has a pH of about 4.5 to about 7.5.

Aspect 48. Use of a high solids content CMC solution according to any one of Aspects 33-47 as a surface treatment agent for paper and board substrates.

Aspect 49. Use of a high solids content CMC solution according to any one of Aspects 33-47 as a barrier coating for paper and board substrates.

Aspect 50. A method for treating a surface of a paper or board substrate comprising applying a CMC solution according to any one of Aspects 33-47 to the surface of the paper or board substrate.

Aspect 51. A surface treated paper or board substrate obtainable by the method of Aspect 50.

Aspect 52. Use of a high solids content CMC solution according to any one of Aspects 33-47 as a co-binder and/or thickener.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein. It being understood that various changes may be made in the function and arrangement of elements described in an exemplary embodiment without departing from the scope of the various embodiments as set forth in the appended claims.

What is claimed is:

1. A method for producing a carboxymethylcellulose (CMC) solution, the method comprising the following steps:
a) obtaining an aqueous solution comprising at least one low molecular weight CMC having a weight average molecular weight of less than 30 kDa; and
b) dissolving at least one high molecular weight CMC having a weight average molecular weight of at least 30 kDa into the solution of step a), wherein the at least one high molecular weight CMC is added as a solid to the solution of step a),
wherein the amount of low and high molecular weight CMC added in steps a) and b), respectively, is such that the total amount of CMC in the final solution is at least 18 wt. % relative to the total weight of the CMC solution.

2. The method of claim 1, wherein the amount of low and high molecular weight CMC added in steps a) and b), respectively, is such that the total amount of CMC in the solution is at least 20 wt. % relative to the total weight of the CMC solution.

3. The method of claim 2, wherein the amount of low and high molecular weight CMC added in steps a) and b), respectively, is such that the total amount of the low molecular weight CMC in the final solution is at least about 15 wt. % and the total amount of high molecular weight CMC in the final solution is at least 5 wt. % kin each case, wt. % being relative to the total weight of the CMC solution.

4. The method of claim 1, wherein the weight ratio of the low molecular weight CMC to the high molecular weight CMC in the CMC solution is from about 3:7 to about 9:1.

5. The method of claim 1, wherein the weight average molecular weight of the low molecular weight CMC is less than 20 kDa and the weight average molecular weight of the high molecular weight CMC is greater than 30 kDa.

6. The method of claim 1, wherein the low molecular weight CMC has a degree of anionic substitution (DS_{A}) of about 0.4 to about 1.5 and wherein the high molecular weight CMC has a degree of anionic substitution (DS_{A}) of about 0.4 to about 1.5.

7. A carboxymethylcellulose (CMC) solution comprising:
a) water;
b) at least one low molecular weight CMC having a weight average molecular weight of less than 30 kDa; and
c) at least one high molecular weight CMC having a weight average molecular weight of at least 30 kDa,
wherein the total amount of CMC in the solution is at least 18 wt. % (relative to the total weight of the CMC solution), and wherein the CMC solution has a viscosity 5000 mPas or less as determined using Brookfield RV, 100 rpm, 40° C., spindle 6.

8. The CMC solution of claim 7, wherein the total amount of CMC in the solution is at least 20 wt. %, wherein the amount of the low molecular weight CMC in the solution is at least 15 wt. %, and wherein the amount of high molecular weight CMC in the solution is at least 5 wt. % (in each case, wt. % being relative to the total weight of the CMC solution.

9. The CMC solution of claim 7, wherein the CMC solution further comprises at least one plasticizer.

10. The CMC solution of claim 7, wherein the CMC solution has a pH of about 4.5 to about 7.5.

11. The CMC solution of claim 7 that is a surface treatment agent for paper and board substrates.

12. A method for treating a surface of a paper or board substrate comprising applying a CMC solution according to claim 7 to the surface of the paper or board substrate.

13. A surface treated paper or board substrate obtained by the method of claim 12.

14. The CMC solution according to claim 7 that is a co-binder and/or thickener.
